(19) United States
(12) Patent Application Publication
(10) Pub. No.: US 2026/0228335 A1
(43) Pub. Date: Aug. 6, 2026

(54) INFORMATION PROCESSING DEVICE

(71) Applicant: ASTEMO, LTD., Tokyo (JP)

(72) Inventors: Shinya SASA, Tokyo (JP); Kota IDEGUCHI, Tokyo (JP); Takashi YAMAGUCHI, Ibaraki (JP)

(21) Appl. No.: 19/157,407

(22) PCT Filed: Apr. 5, 2024
(86) PCT No.: PCT/JP2024/014152

§ 371 Date: Aug. 18, 2025

(30) Foreign Application Priority Data
May 19, 2023 (JP) 2023-082877

(51) Int. Cl. G06F 21/56

(52) U.S. Cl. CPC G06F 21/566; G06F 2221/034

(57) ABSTRACT

An information processing device 100 includes: a log acquisition unit 101 configured to acquire a log of an in-vehicle apparatus 112; a determination unit 102 configured to determine occurrence or non-occurrence of a predetermined target event among events occurring in the in-vehicle apparatus 112 based on the acquired log; a retrieval unit 103 configured to execute a retrieving process for the log when it is determined that the target event has occurred; and a transmission unit 104 configured to transmit the log acquired in the retrieving process to a center. The retrieving process includes an identifying process of identifying a related event related to the target event, an acquisition process of acquiring the log for determining whether the related event identified in the identifying process has occurred, and a determination process of determining whether the related event has occurred based on the log acquired in the acquisition process.

### TECHNICAL FIELD

The present invention relates to an information processing device, and particularly, to an information processing device capable of narrowing down a log to be transmitted to a center that monitors a vehicle by identifying a log of an in-vehicle apparatus related to a security incident when a security incident occurs.

### BACKGROUND ART

Connected cars that enable various functions to be used by connecting the cars to the Internet have spread. When connected cars undergo security attacks, the security attacks can lead to serious events that threaten human lives, and countermeasure against such attacks needs to be taken quickly.

Therefore, in recent years, a vehicle security operation center (VSOC) for automobiles, which continuously monitors a state of vehicles in use, analyzes causes of security incidents when security incidents occur, and handles the security incidents through remote operations on the vehicles, has been studied. A security operation center collects data such as logs from vehicles, identifies causes of incidents through manual analysis by an analyst or automatic analysis of a system, and prepares necessary countermeasures.

However, with complication of in-vehicle systems, the amount of data that can be acquired by vehicles has increased, and a center consumes much of the communication band when all data is transmitted to the center. Therefore, by narrowing down data related to incidents that have occurred and transmitting the data to the center, consumption of the communication band can be reduced.

As a technology of the related art related to vehicle data collection, Patent Literature 1 discloses a monitoring device that classifies logs from monitoring targets into passive collection logs and active collection logs, and transmits a request for collecting the active collection logs to other monitoring targets based on alerts generated from the passive collection logs.

### CITATION LIST

### Patent Literature

Patent Literature 1: JP 2021-027505 A

### SUMMARY OF INVENTION

### Technical Problem

However, in the technology disclosed in Patent Literature 1, it is necessary to communicate with a monitoring device in order to determine logs to be collected. Therefore, when communication is interrupted, for example, when the vehicle is traveling inside a tunnel or outside of a communication range, a log collection process cannot be executed on the vehicle side. Accordingly, in order to transmit a log to the monitoring device at the time of communication recovery, it is necessary to execute a process of storing the log that may be collected by the monitoring device in the vehicle. Thus, there may be problems that a storage of an in-vehicle system is correspondingly consumed and the logs that cannot be stored cannot be transmitted.

The present invention has been made in view of the above circumstances, and an object of the present invention is to provide an information processing device capable of determining a log to be transmitted with restricted resources on a vehicle side when a security incident occurs in the vehicle.

### Solution to Problem

According to an aspect of the present invention, for example, an information processing device includes: a log acquisition unit configured to acquire a log of an in-vehicle apparatus; a determination unit configured to determine occurrence or non-occurrence of a predetermined target event among events occurring in the in-vehicle apparatus based on the acquired log; a retrieval unit configured to execute a retrieving process for the log when it is determined that the target event has occurred; and a transmission unit configured to transmit the log acquired in the retrieving process to a center. The retrieving process includes an identifying process of identifying a related event related to the target event, an acquisition process of acquiring the log for determining whether the related event identified in the identifying process has occurred, and a determination process of determining whether the related event has occurred based on the log acquired in the acquisition process.

### Advantageous Effects of Invention

According to the present invention, when a security incident occurs in a vehicle, a log related to the security incident can be identified on the vehicle side, and logs to be transmitted to a center can be narrowed down.

### BRIEF DESCRIPTION OF DRAWINGS

FIG. 1 is a block diagram illustrating a functional configuration of an information processing device according to an example of the present invention.

FIG. 2 is a block diagram illustrating an overview of a processing flow executed by the information processing device according to the example of the present invention.

FIG. 3 is a diagram illustrating a content example of a constant monitoring attack event DB according to the example of the present invention.

FIG. 4 is a diagram illustrating a content example of a related attack event DB according to the example of the present invention.

FIG. 5 is a diagram illustrating a content example of an attack event-related log DB according to the example of the present invention.

FIG. 6 is a flowchart illustrating a process executed by a log acquisition unit according to the example of the present invention.

FIG. 7 is a flowchart illustrating a process executed by a determination unit according to the example of the present invention.

FIG. 8 is a flowchart illustrating a process executed by a retrieval unit according to the example of the present invention.

FIG. 9 is a flowchart illustrating a process executed by a retrieval unit in response to an additional retrieval request according to the example of the present invention.

### DESCRIPTION OF EMBODIMENTS

Hereinafter, examples of the present invention will be described in detail with reference to the drawings using examples.

First, a functional configuration of an information processing device 100 according to an example of the present invention will be described. The information processing device 100 may be, for example, a computer that includes a memory and a processor as a hardware configuration.

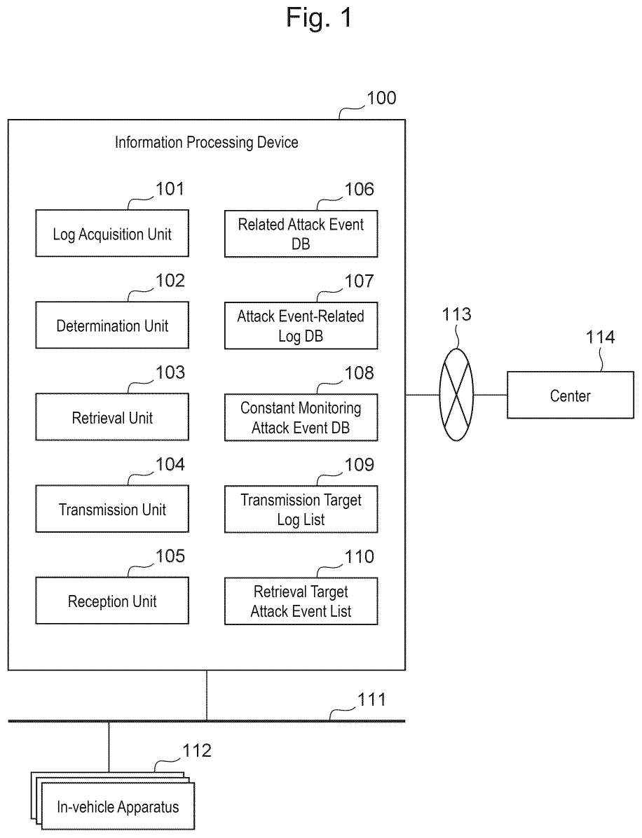

FIG. 1 is a block diagram illustrating a functional configuration of the information processing device 100. The information processing device 100 includes a log acquisition unit 101, a determination unit 102, a retrieval unit 103, a transmission unit 104, a reception unit 105, a related attack event database (DB) 106, an attack event-related log DB 107, a constant monitoring attack event DB 108, a transmission target log list 109, and a retrieval target attack event list 110. Details of the functional units and the databases will be described below. The information processing device 100 is a computer that is mounted on a vehicle and includes a central processing unit (CPU) and a memory.

The information processing device 100 is also connected to a plurality of in-vehicle apparatuses 112 via a communication path 111. The communication path 111 may physically include a plurality of communication buses, and standards of the communication buses may be the same or different. The in-vehicle apparatus 112 is any of various electronic control units (ECUs) controlling a vehicle.

The information processing device 100 is also connected to the center 114 via a network 113. The center 114 is the above-described VSOC.

The functional block diagram illustrated in FIG. 1 is exemplary, and the unit and name of the function are not limited thereto. For example, the function implemented by the retrieval unit 103 in the present example may be implemented by another functional unit illustrated in FIG. 1 or may be implemented by a functional unit not illustrated in FIG. 1.

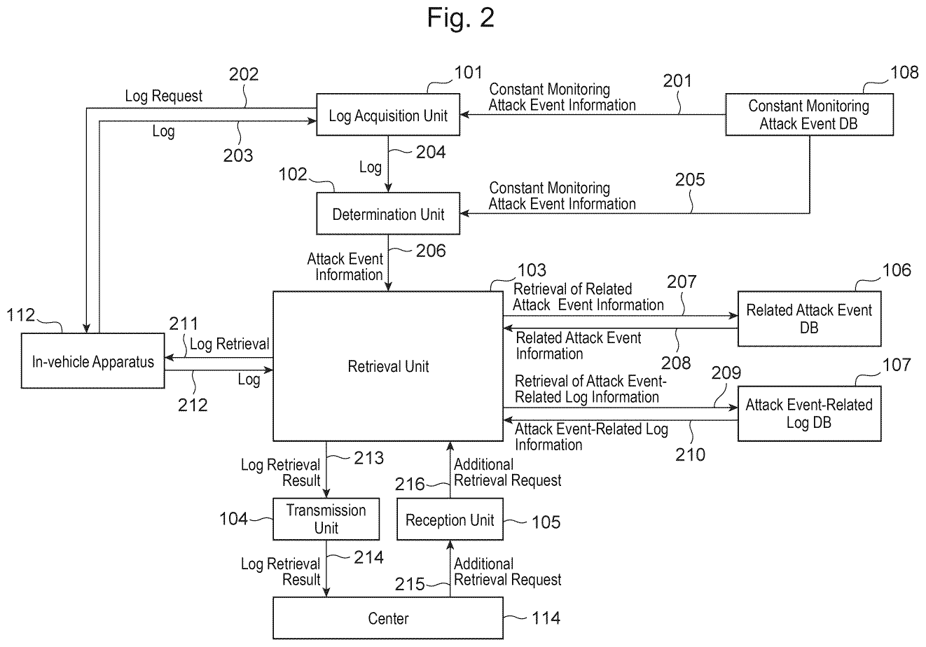

FIG. 2 is a diagram illustrating an overview of the entire processing flow executed by the information processing device 100.

The log acquisition unit 101 is a functional unit that periodically acquires a log from the in-vehicle apparatus 112. The log acquisition unit 101 acquires constant monitoring attack event information in advance from the constant monitoring attack event DB 108 (201). Here, the constant monitoring attack event DB 108 is a database in which attack events to be monitored are stored, and details thereof will be described below. The attack event is an event caused by an attack on the in-vehicle apparatus. The constant monitoring attack event information is information indicating an attack event for which the occurrence thereof is being constantly monitored and a log that is a basis for determining that an attack event has occurred.

The log acquisition unit 101 periodically gives a request for a log (entire log) described in the constant monitoring attack event information from the in-vehicle apparatus 112 (202). The in-vehicle apparatus 112 delivers the log to the log acquisition unit 101 in response to the request (203), and the log acquisition unit 101 delivers the acquired log to the determination unit 102 (204).

The determination unit 102 is a functional unit that determines whether an attack event has occurred based on the log of the in-vehicle apparatus received from the log acquisition unit 101.

The determination unit 102 acquires the constant monitoring attack event information in advance from the constant monitoring attack event DB 108 (205). When the log from the log acquisition unit 101 is received, the determination unit 102 determines whether any attack event has occurred based on the log information. When it is determined that the attack event has occurred, attack event information regarding the attack event is transmitted to the retrieval unit 103 (206).

The retrieval unit 103 is a functional unit that, when it is determined that an attack event has occurred, executes a log retrieving process based on the attack event information received from the determination unit 102. When the attack event information is received from the determination unit 102, the retrieval unit 103 retrieves the related attack event information related to the attack event in the related attack event DB 106 (207). Here, the related attack event information is information indicating a relevance between attack events. When there is a high likelihood of another attack event occurring in a case where a certain attack event has occurred, the relationship between the attack events is recorded in the related attack event DB 106 as the related attack event information. When the related attack event information is acquired (208), the retrieval unit 103 identifies another attack event related to the attack event information received from the determination unit 102 using the related attack event information.

Subsequently, the retrieval unit 103 determines whether the identified related attack event has occurred based on the log of the in-vehicle apparatus 112. Therefore, the retrieval unit 103 retrieves and acquires the attack event-related log information related to the related attack event in the attack event-related log DB 107 (209, 210). Here, the attack event-related log information is information indicating a log affected when a certain attack event occurs, and is used to determine whether the attack event has occurred. The retrieval unit 103 identifies a log related to the related attack event using the acquired attack event-related log information, and requests the log from the in-vehicle apparatus 112 (211). Upon receiving the log (retrieval log) (212), the retrieval unit 103 determines whether the related attack event has occurred based on the received log.

In other words, the retrieving process executed by the retrieval unit 103 includes an identifying process of identifying a related attack event related to the attack event, an acquisition process of acquiring a log for determining whether the related attack event identified in the identifying process has occurred, and a determination process of determining whether the related attack event has occurred based on the log acquired in the acquisition process.

When it is determined that the related attack event has occurred, the retrieval unit 103 further executes the processes 207 to 212 on the related attack event, and identifies the related attack event for the related attack event, retrieves the log, and determines whether the related event has occurred. The retrieval unit 103 sequentially retrieves the log by repeating the processes. In other words, when it is determined that a certain related attack event has occurred, the retrieval unit 103 repeatedly executes the retrieving process in association with the related attack event.

The retrieval unit 103 delivers the log acquired through the above processes to the transmission unit 104 as a log retrieval result (213). The transmission unit 104 transmits the received log retrieval result to the center 114 (214).

According to the above processes, when it is determined that any attack event has occurred, only the log related to the attack event can be acquired from the in-vehicle apparatus 112 and transmitted to the center 114. In the case of a data structure in which attack events such as fault trees (FT) are arranged in a tree shape as in Patent Literature 1, the number of patterns, that is, the number of trees tends to become enormous. However, in the present example, by arranging data prepared in advance as related attack event information indicating the relevance between attack events and attack event-related log information indicating the relevance between attack events and logs, it is possible to reduce the amount of data required for retrieving logs. By sequentially collecting the logs while determining whether a related attack event has occurred, it is possible to selectively collect logs related to attack events that are highly likely to occur, and it is possible to efficiently acquire logs as compared with a method of collectively acquiring logs.

The reception unit 105 is a functional unit that receives an additional retrieval request from the center 114 (215) and delivers the additional retrieval request to the retrieval unit 103 (216). The retrieval unit 103 retrieves the log in response to the additional retrieval request and transmits a result to the center 114 via the transmission unit 104 again.

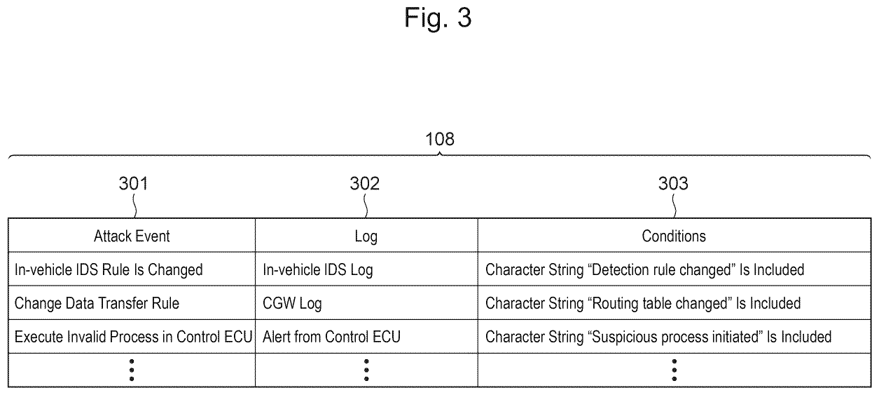

FIG. 3 is a diagram illustrating a content example of the constant monitoring attack event DB 108.

The constant monitoring attack event DB 108 is a DB in which a log 302 and a condition 303 that is a basis for determining that an attack event has occurred are associated with the attack event 301 to be constantly monitored. That is, when there is the log 302 satisfying the condition 303, the determination unit 102 determines that the attack event 301 corresponding to the log 302 has occurred. In the present example, for example, an attack on an in-vehicle intrusion detection system (IDS) is normally a monitoring target. When inclusion of a condition “Detection rule changed” in a character string is detected in a log of the in-vehicle IDS, it is determined that an attack event such as a rule change of the in-vehicle IDS by a third party has occurred. The constant monitoring attack event DB 108 may include a plurality of records in which the attack events 301 are common. In this case, when there is a log corresponding to any one of the sets of the log 302 and the condition 303 associated with the same attack event 301, it is determined that the attack event 301 has occurred.

FIG. 3 illustrates an example of the constant monitoring attack event DB 108 that may have, for example, a data structure in which more complicated conditions for determining that an attack event has occurred can be set.

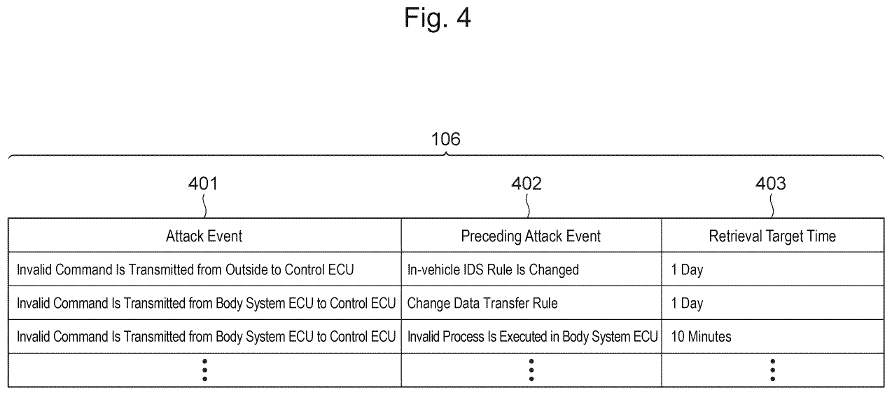

FIG. 4 is a diagram illustrating a content example of the related attack event DB 106.

In the related attack event DB 106 according to the present example, one of attack events that are highly likely to have been executed before a certain attack event 401 when the attack event occurs is associated as a preceding attack event 402. A time width that is a retrieval target in a log retrieving process by the retrieval unit 103 as described below is designated as a retrieval target time 403. The retrieval unit 103 determines whether the preceding attack event 402 has occurred in the attack event 401 based on a log obtained by tracing back the retrieval target time 403 before an occurrence time of the attack event 401. For example, when the content of the related attack event DB is as illustrated in FIG. 4 and it is determined that the attack event “Invalid command transmission from the outside to the control ECU” has occurred at 2023/2/20 10:00, the retrieval unit 103 retrieves a log for determining whether the preceding attack event “in-vehicle IDS rule change” has occurred for a period from 2023/2/19 10:00 to 2023/2/20 10:00, and determines whether the preceding attack event has occurred based on the retrieved log.

In the related attack event DB 106, for example, for an attack event in which a specific operation is executed on a certain ECU, preparation such as acquisition of authority for enabling the operation, transmission of a signal for causing the ECU to execute the operation, and the like can be associated as preceding attack events. For an attack event of transmitting a signal to a certain ECU, preparation such as authority acquisition and unauthorized software installation for causing the transmission source device to transmit a signal, an operation of changing a routing table or a filtering rule of the communication control device on the communication path to cause the signal to reach the transmission destination ECU from the transmission source device, and the like can be associated as preceding attack events.

In the related attack event DB 106, not only the association between the attack event and the preceding attack event as in the present example but also a subsequent attack event that is highly likely to be executed after the occurrence of the attack event may be associated with the attack event.

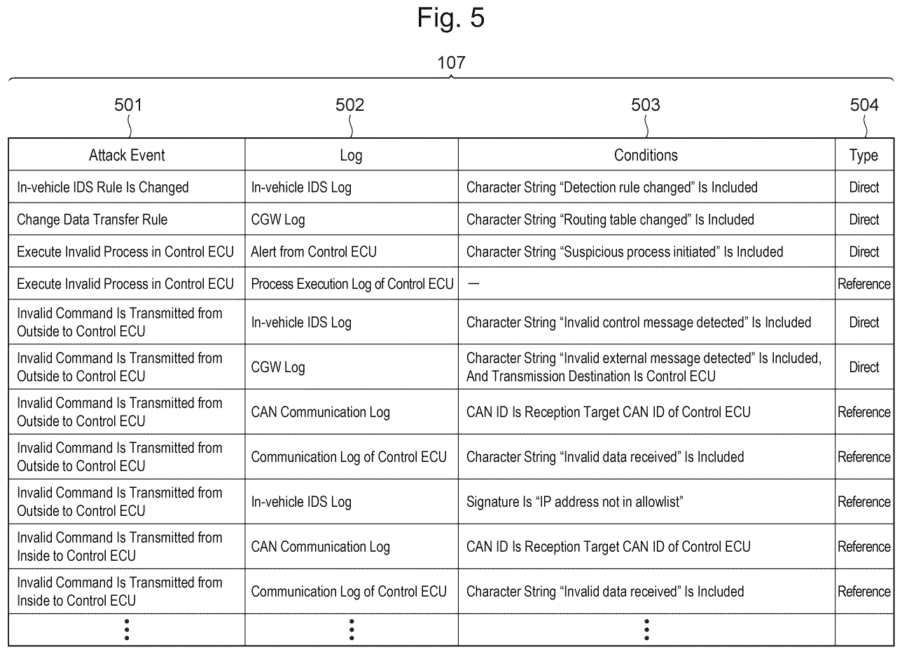

FIG. 5 is a diagram illustrating a content example of the attack event-related log DB 107.

The attack event-related log DB 107 is a DB in which a log 502, a condition 503, and a log type 504 that are bases for determining that an attack event has occurred are associated with a certain attack event 501. Here, the log type 504 according to the present example takes two types of values of “direct” and “reference”. “Direct” indicates that it can be directly determined that the attack event 501 has occurred when there is the log 502 satisfying the condition 503. “Reference” indicates that the log 502 satisfying the condition 503 is affected by the attack event 501, but it cannot be directly determined that the attack event 501 has occurred only due to the existence of such a log. When there is the log 502 satisfying a condition 503 in which the type 504 is “Direct”, the retrieval unit 103 determines that an attack event 501 corresponding to the log 502 has occurred.

As illustrated in FIG. 5, the attack event-related log DB 107 may include a plurality of records in which the attack event 501 is common. In this case, when there is any log satisfying the corresponding condition 503 among the logs 502 which is associated with the same attack event 501 and of which the type 504 is “Direct”, it is determined that the attack event 501 has occurred. For example, when there is an in-vehicle IDS log including a character string “Invalid control message detected” or a central gateway (CGW) log including a character string “Invalid external message detected” and a transmission destination that is the control ECU, for the attack event “Invalid command transmission from the outside to the control ECU”, it is determined that the attack event has occurred. FIG. 5 illustrates an example of the attack event-related log DB 107, and may have a data structure in which, for example, a more complicated condition for determining that an attack event has occurred can be set.

The content of the constant monitoring attack event DB 108, the related attack event DB 106, and the attack event-related log DB 107 may be written in a machine-readable format so that the determination unit 102 and the retrieval unit 103 can mechanically process the content. The constant monitoring attack event information, the related event information, and the attack event-related log information for the plurality of ECUs may be collectively written.

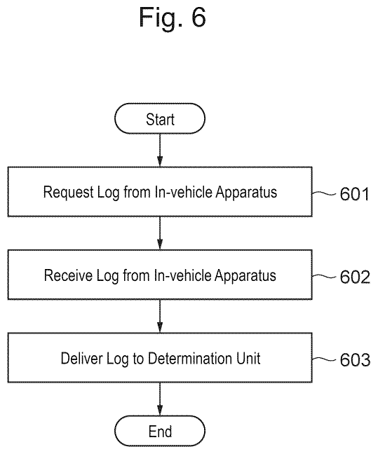

FIG. 6 is a flowchart illustrating an example of a process executed by the log acquisition unit 101.

The log acquisition unit 101 requests a log from the in-vehicle apparatus 112 based on the constant monitoring attack event information acquired in advance from the constant monitoring attack event DB 108 (601). For example, in the case of the constant monitoring attack event DB 108 of FIG. 3, “in-vehicle IDS log”, “CGW log”, “alert from control ECU”, and the like are described as the log 302, and the log acquisition unit 101 periodically requests the in-vehicle apparatus 112 to transmit these logs.

Subsequently, the log acquisition unit 101 receives a log transmitted from the in-vehicle apparatus 112 in response to the log request (602), and further transmits the received log to the determination unit 102 (603). As a log acquisition method, instead of the log acquisition unit 101 periodically requesting the log from the in-vehicle apparatus 112 as in the present example, the in-vehicle apparatus 112 may periodically transmit the log to be collected by itself to the log acquisition unit 101.

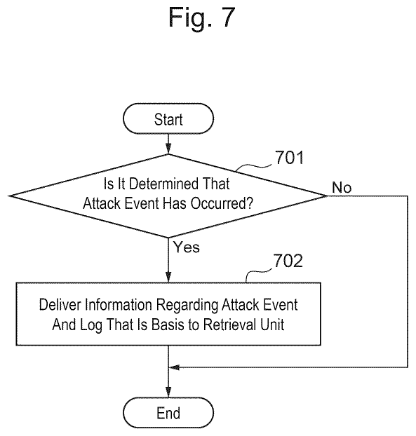

FIG. 7 is a flowchart illustrating an example of a process executed by the determination unit 102. Upon receiving the log from the log acquisition unit 101, the determination unit 102 refers to the constant monitoring attack event information acquired from the constant monitoring attack event DB 108 in advance, and determines whether there is the log 302 satisfying the condition 303 (701). When there is such a log, it is determined that the corresponding attack event 301 has occurred, and the attack event 301 and the log that is a basis of the occurrence thereof, that is, the log 302 satisfying the condition 303, are delivered to the retrieval unit 103 (702). Hereinafter, the attack event transmitted to the retrieval unit 103 is referred to as a trigger attack event. At that time, an occurrence time of the trigger attack event is determined based on the log, and the information is also delivered to the retrieval unit 103. When there is no log 302 satisfying the condition 303, the determination unit 102 ends the process.

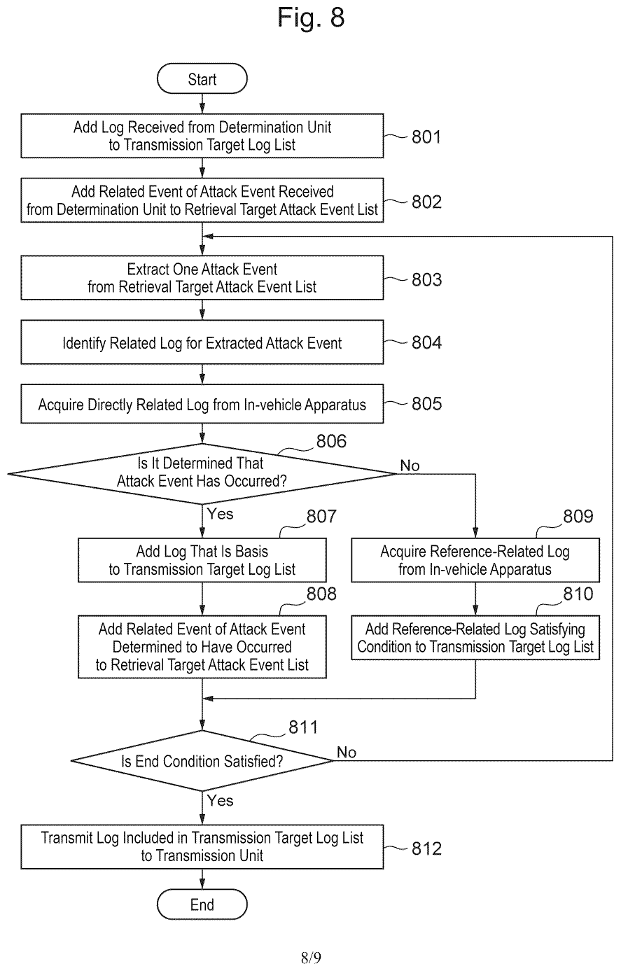

FIG. 8 is a flowchart illustrating an example of a process executed by the retrieval unit 103.

The main processes of the retrieval unit 103 include an initial process (801 and 802) for the information received from the determination unit 102, retrieval of the log related to the attack event (803 to 805), determination of whether an attack event occurs (806), a process when an attack event occurs (807 and 808), a process when no attack event occurs (809 and 810), determination of the retrieval end condition (811), and delivery of the collected logs (812).

First, the retrieval unit 103 adds the log received from the determination unit 102 to the transmission target log list 109 (801). Here, the transmission target log list is a list that stores logs to be delivered to the transmission unit 104 in a process 812 to be described below. At this time, as information to be used as a reference for log analysis in the center 114, the information may be added to the transmission target log list in association with the information regarding the trigger attack event received from the determination unit 102.

Subsequently, for the trigger attack event received from the determination unit 102, the retrieval unit 103 identifies a related attack event with reference to the related attack event DB 106 and adds the identified attack event to the retrieval target attack event list 110 (802). Here, the retrieval target attack event list is a list that stores attack events as targets of the process (803 to 805) of retrieving the related logs. In the process 802, the retrieval unit 103 first retrieves and acquires, from the related attack event DB 106, related attack event information in which the “attack event” column 401 in the related attack event DB 106 indicates the trigger attack event for the trigger attack event received from the determination unit 102 (see FIG. 4). Then, the attack events included in the “preceding attack event” column 402 of the acquired related attack event information are added to the retrieval target attack event list 110. At this time, a start time and an end time of a log retrieval target period are calculated from the “retrieval target time” column 403 of an occurrence time of the trigger attack event and the related event information, and are added to the retrieval target attack event list 110.

Subsequently, the retrieval unit 103 extracts one attack event from the retrieval target attack event list 110 (803). At this time, information regarding the start time and the end time of the retrieval target period recorded in the retrieval target attack event list is also acquired.

Subsequently, the retrieval unit 103 identifies a related log for the extracted attack event (804). In the process 804, the retrieval unit 103 first retrieves and acquires attack event-related log information in which the “attack event” column 501 indicates the attack event with reference to the attack event-related log DB 107 for the extracted attack event (see FIG. 5). Then, the log 502 included in the acquired attack event-related log information is set as a related log.

Subsequently, the retrieval unit 103 acquires the directly related log, that is, the related log of which the type 504 in the attack event-related log DB 107 is “Direct” from the in-vehicle apparatus (805). At this time, the related log in the retrieval target period acquired in the process 803 is acquired. As a method of acquiring the log, as described as the flows 211 and 212 in FIG. 2, a scheme in which the log is requested from the in-vehicle apparatus and the in-vehicle apparatus responds to the request, or a scheme of directly acquiring a file in which the log is recorded with reference to the retrieval unit 103 may be used. At a time at which the related log is directly acquired from the in-vehicle apparatus, the related log may be acquired by narrowing down the logs to only the directly related log that may satisfy the condition 503.

Subsequently, the retrieval unit 103 determines whether there is a log satisfying the corresponding condition 503 among the acquired directly related logs, and determines that an attack event has occurred when there is such a log (806). At this time, the occurrence time of the attack event is also determined based on the log.

When it is determined that the attack event has occurred (in the case of “Yes” in 806), the retrieval unit 103 adds the log that is a basis of the attack event, that is, the directly related log satisfying the corresponding condition 503 to the transmission target log list 109 (807). At this time, as information to be used as a reference for log analysis at the center, the information may be added to the transmission target log list 109 in association with the information of the attack event. Further, the retrieval unit 103 adds the related attack event corresponding to the attack event determined to have occurred to the retrieval target attack event list 110 (808). In the process 808, similarly to the process 802, the retrieval unit 103 retrieves and acquires the related attack event information in which the “attack event” column 401 indicates the attack event from the related attack event DB 106 for the attack event determined to have occurred. Then, the attack events included in the “preceding attack event” column 402 of the acquired related attack event information are added to the retrieval target attack event list 110. At this time, the start time and the end time of the log retrieval target period are calculated from the occurrence time of the attack event determined to have occurred and the “retrieval target time” column 403 of the related event information, and are added to the retrieval target attack event list 110.

Conversely, when it is not determined in the process 806 that the attack event has occurred, the retrieval unit 103 acquires the reference-related log, that is, the related log of which the type 504 is “reference” in the attack event-related log DB 107 from the in-vehicle apparatus (809). At this time, the related log in the retrieval target period acquired in the process 803 is acquired. At a time at which reference-related logs are acquired from the in-vehicle apparatus, the reference-related logs may be narrowed down to only the reference-related log that possibly satisfies the condition 503. Hereinafter, of attack events described in each DB, an attack event that is not determined to have occurred is referred to as an undetermined event. Subsequently, it is determined whether there is a reference-related log that satisfies the corresponding condition 503 among the acquired reference-related logs. When there is such a log, the reference-related log is added to the transmission target log list 109 (810). At this time, as information to be used as a reference for log analysis in the center 114, the information may be added to the transmission target log list in association with the information regarding the undetermined event. Information for distinguishing a directly related log from the reference-related log may be added to the transmission target log list 109.

After the process 808 or 810 completes, the retrieval unit 103 determines whether an end condition is satisfied (811). Here, it is assumed that the end condition is set in the retrieval unit 103 in advance. For example, by setting that a capacity of the logs included in the transmission target log list reaches a certain value as the end condition, an amount of data to be transmitted to the center 114 can be inhibited. For each attack event included in the retrieval target attack event list, the number of retrieving processes until addition of the attack event to the retrieval target attack event list 110 is counted, and a minimum value that reaches a certain value can be set as the end condition. For example, when the attack event A is added to the retrieval target attack event list 110 in the process 802 and the attack event B is added to the retrieval target attack event list 110 in the process 808 for the attack event A, the number of retrieving processes until addition of the attack event B to the retrieval target attack event list 110 is 2. In the process 803, by extracting the attack event of which the number of retrieving processes until the addition to the retrieval target attack event list 110 is the minimum and using the fact that the minimum value of the number of retrieving processes reaches a certain value as the end condition, it is possible to acquire only a log related to the attack event of which the number of retrieving processes is equal to or less than the certain value, that is, which is highly related to the trigger attack event.

When the end condition is satisfied, the retrieval unit 103 delivers the log and accompanying information included in the transmission target log list 109 to the transmission unit 104 as a log retrieval result. Thereafter, the transmission unit 104 transmits the log retrieval result received from the retrieval unit 103 to the center 114.

When there is an additional retrieval request from the center 114, the reception unit 105 receives an additional retrieval request and delivers the additional retrieval request to the retrieval unit 103. For example, when it is determined through the log analysis in the center 114 that there is a high likelihood of an undetermined event having occurred, it is conceivable that a retrieval request for a log related to an undetermined event is transmitted from the center 114 to the reception unit 105. Alternatively, when it is determined that there is a high likelihood that an attack event that has not been a retrieval target by the retrieval unit 103 has occurred, it is conceivable that a retrieval request for the attack event is transmitted to the reception unit 105.

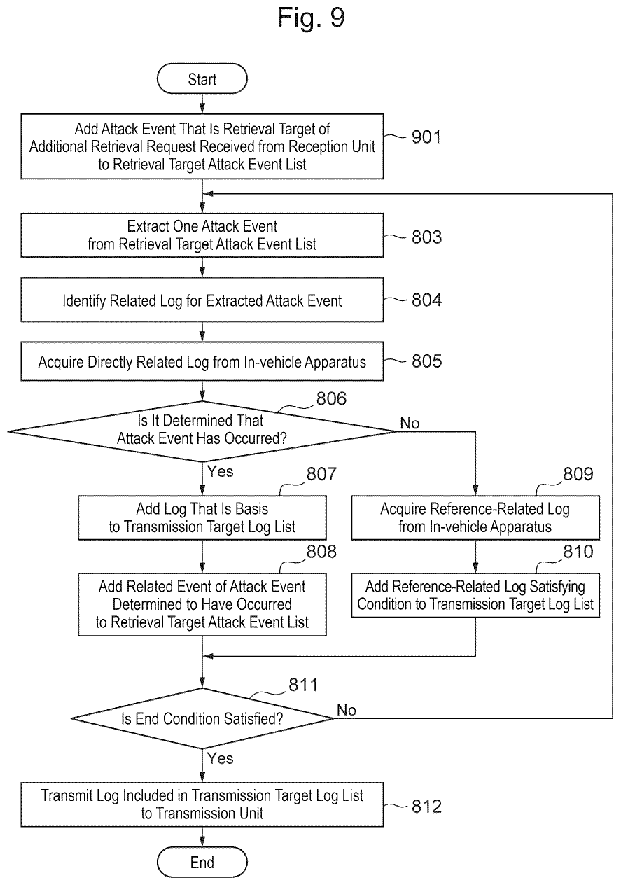

FIG. 9 is a diagram illustrating an example of a process of the retrieval unit 103 when a retrieval request for a log related to a specific attack event is received as an additional retrieval request from the reception unit 105.

First, the retrieval unit 103 adds the attack event that is the target of the additional retrieval request received from the reception unit 105 to the retrieval target attack event list 110 (901). Thereafter, the processes 803 to 812 are executed similarly to the case where the attack event information is received from the determination unit 102 (FIG. 8), and the log is delivered to the transmission unit 104. Thereafter, the transmission unit 104 transmits the log received from the retrieval unit 103 to the center 114.

The following operational effects can be obtained in the examples of the present invention described above.

(1) An information processing device according to the present invention includes: a log acquisition unit configured to acquire a log of an in-vehicle apparatus; a determination unit configured to determine occurrence or non-occurrence of a predetermined target event among events occurring in the in-vehicle apparatus based on the acquired log; a retrieval unit configured to execute a retrieving process for the log when it is determined that the target event has occurred; and a transmission unit configured to transmit the log acquired in the retrieving process to a center. The retrieving process includes an identifying process of identifying a related event related to the target event, an acquisition process of acquiring the log for determining whether the related event identified in the identifying process has occurred, and a determination process of determining whether the related event has occurred based on the log acquired in the acquisition process.

With the above configuration, when the security incident occurs, it is possible to narrow down the log to be transmitted to the center that monitors the vehicle by identifying the log of the in-vehicle apparatus related to the security incident.

(2) The transmission unit transmits the log acquired before the retrieving process to the center when the log for determining that the related event has occurred is not acquired in the retrieving process. By analyzing the logs, it is possible to execute more detailed analysis on the related event.

(3) The information processing device further includes a reception unit configured to receive a request from the center side. The retrieval unit executes the retrieving process using the related event that is a target of the retrieving process as the target event in response to a request from the center. In this way, the retrieving process can be executed not only from the apparatus side but also from the center side.

(4) The retrieval unit executes the retrieving process using another event that is not a target of the retrieving process as the target event in response to a request from the center. Accordingly, the likelihood of being able to discover new attack events that have not been described in a database or a list increases.

(5) The retrieval unit stops the retrieving process when the retrieving process has been repeated a predetermined number of times or when the log to be transmitted to the center has been acquired beyond a predetermined capacity or more. Accordingly, it is possible to inhibit a data capacity to be transmitted.

(6) When the transmission unit acquires a predetermined type of log indicating higher relevance than other types of logs among types of logs indicating relevance with occurrence of the event, the transmission unit excludes the other types of logs and transmits the predetermined type of log to the center. That is, by transmitting only an important log to the center, it is possible to inhibit a data capacity to be transmitted as in (5).

(7) When it is determined that the related event has occurred, the retrieval unit repeatedly executes the retrieving process using the related event as the target event. Accordingly, it is possible to sequentially discover related attack events.

(8) When the transmission unit does not acquire a predetermined type of log indicating higher relevance than other types of logs among types of logs indicating relevance with occurrence of the event, the transmission unit transmits the other types of logs to the center. By analyzing such logs, the likelihood of discovering a new attack event increases.

The present invention is not limited to the above examples, and various modifications can be made. For example, the above-described examples have been described in detail in order to describe the present invention in an easy-to-understand manner, and the present invention is not necessarily limited to aspects including all the described configurations. Some of the configurations of one example can be replaced with configurations of another example. The configurations of another example can be added to the configurations of a certain example. Some of the configurations of each example can be deleted, or other configurations can be added or replaced.

### REFERENCE SIGNS LIST

100 Information processing device
101 Log acquisition unit
102 Determination unit
103 Retrieval unit
104 Transmission unit
105 Reception unit
112 In-vehicle apparatus
114 Center

1. An information processing device comprising:
a log acquisition unit configured to acquire a log of an in-vehicle apparatus;
a determination unit configured to determine occurrence or non-occurrence of a predetermined target event among events occurring in the in-vehicle apparatus based on the acquired log;
a retrieval unit configured to execute a retrieving process for the log when it is determined that the target event has occurred; and
a transmission unit configured to transmit the log acquired in the retrieving process to a center,
wherein the retrieving process includes
an identifying process of identifying a related event related to the target event,
an acquisition process of acquiring the log for determining whether the related event identified in the identifying process has occurred, and
a determination process of determining whether the related event has occurred based on the log acquired in the acquisition process.

2. The information processing device according to claim 1, wherein the transmission unit transmits the log acquired before the retrieving process to the center when the log for determining that the related event has occurred is not acquired in the retrieving process.

3. The information processing device according to claim 2, further comprising:
a reception unit configured to receive a request from the center side,
wherein the retrieval unit executes the retrieving process using the related event that is a target of the retrieving process as the target event in response to a request from the center.

4. The information processing device according to claim 3, wherein the retrieval unit executes the retrieving process using another event that is not a target of the retrieving process as the target event in response to a request from the center.

5. The information processing device according to claim 1, wherein the retrieval unit stops the retrieving process when the retrieving process has been repeated a predetermined number of times or when the log to be transmitted to the center has been acquired beyond a predetermined capacity or more.

6. The information processing device according to claim 1, wherein, when the transmission unit acquires a predetermined type of log indicating higher relevance than other types of logs among types of logs indicating relevance with occurrence of the event, the transmission unit excludes the other types of logs and transmits the predetermined type of log to the center.

7. The information processing device according to claim 1, wherein, when it is determined that the related event has occurred, the retrieval unit repeatedly executes the retrieving process using the related event as the target event.

8. The information processing device according to claim 1, wherein, when the transmission unit does not acquire a predetermined type of log indicating higher relevance than other types of logs among types of logs indicating relevance with occurrence of the event, the transmission unit transmits the other types of logs to the center.
